(19) United States
(12) Patent Application Publication
(10) Pub. No.: US 2011/0264248 A1
(43) Pub. Date: Oct. 27, 2011

(54) AUDIO PLAYING CIRCUIT FOR A COMPUTER

(75) Inventor: CHUN-YING LU, Taipei (TW)

(73) Assignee: INVENTEC CORPORATION, Taipei (TW)

(21) Appl. No.: 12/905,422

(22) Filed: Oct. 15, 2010

(30) Foreign Application Priority Data
Apr. 23, 2010 (TW) 099112800

(51) Int. Cl. G06F 17/00

(52) U.S. Cl. 700/94

(57) ABSTRACT

An audio playing circuit for a computer is disclosed, which comprises: an audio source input to connect with an external audio apparatus; an audio decoder coupled to the audio source input, to decode an audio source signal from the same; an input/output controller, coupled to the audio source input; a selector, coupled to the audio source input, audio decoder and input/output controller, to select an audio signal according to an ON/OFF state of the computer; an audio amplifier coupled to the selector, to amplify the audio signal form the selector; and a speaker coupled to the audio amplifier, to voice the signal from the audio amplifier. According to the present invention, when the computer is in OFF state, the input/output controller activates the selector to select the audio signal directly from the audio source input to the audio amplifier, without been audio decoded.

### TECHNICAL FIELD

The present disclosure relates to an audio playing circuit for a computer, and more particularly, to an audio playing circuit that can play audio files of an external audio apparatus with the computer's built-in speakers, even when the computer is shut down.

### TECHNICAL BACKGROUND

The main advantages of a laptop or notebook computer are its compactness and portability, so it is quite attractive for such a portable computer to work as an audio player. To turn on a computer, it needs quite a long time to start the operational system therein before the computer is completely ready to work. For a user who wants only to listen to the audio player, he has to wait and wait. Besides, the power consumption is relatively high for the computer to work only as an audio player, without doing anything else. Therefore, computer manufacturers have endeavored themselves to develop an audio playing module in a computer to play audios with no need to load the operational system completely.

The Taiwan patent application no. 552552 discloses an audio playing system, comprising an operational system and an audio playing software, to allow a user to enjoy the audio playing function after the computer is shut down. Under such a situation, electrical power has to be supplied to the CPU, DRAM, operational system, and audio input and output devices, and the audio files need to be put in a memory card or a Disc player in advance.

### TECHNICAL SUMMARY

To obviate the disadvantages of the prior art, a main object of the present invention is to disclose an audio playing circuit for a computer, so that even after the computer is turned off, the computer can still play audio files of an external audio apparatus plugged into an audio source input of the computer with its built-in speakers.

It is another object of the invention, to provide a time delay unit to diminish the noise once the audio playing circuit is turned on.

The objects are accomplished, in one aspect of the invention, by disclosing an audio playing circuit for a computer, comprising:
an audio source input, to connect with an external audio apparatus;
an audio decoder coupled to the audio source input, to decode an audio signal;
an input/output controller, coupled to the audio source input;
a switch, coupled to the audio source input and the audio decoder, to select an audio signal according to the input/output controller;
an audio amplifier coupled to the switch, to amplify the audio signal; and
a speaker coupled to the audio amplifier, to voice the signal from the audio amplifier;
wherein if the computer is in OFF state, then the input/output controller activates the switch to select the audio signal directly from the audio source input, otherwise the input/output controller select the audio signal decoded by the audio decoder.

Preferably, the audio playing circuit further comprises a time delay unit activated by the input/output controller, to delay turning on of the audio amplifier to diminish the noise impact once the audio source input acts.

Preferably, the time delay unit is composed of an “OR” logic gate.

Preferably, the audio apparatus is an MP3 player, an MP4 player, a radio, or the like.

Preferably, if the computer is working well in ON state, an audio signal travels sequentially through the audio source input, the audio decoder, the switch, the audio amplifier, and the speaker to be voiced out.

Preferably, if the computer is turned off, an audio signal travels sequentially through the audio source input, the switch, the time delay unit, the audio amplifier, and the speaker to be voiced out; wherein the time delay unit is used to delay turning on of the audio amplifier to diminish the noise impact once the audio source input acts.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is an architecture diagram of an audio playing circuit for a computer according to an embodiment of the present invention.

FIG. 2 is a detailed circuit diagram according to FIG. 1.

### DESCRIPTION OF THE EXEMPLARY EMBODIMENTS

For further understanding the fulfilled functions and structural characteristics of the disclosure, exemplary embodiments cooperating with detailed description are presented as the follows.

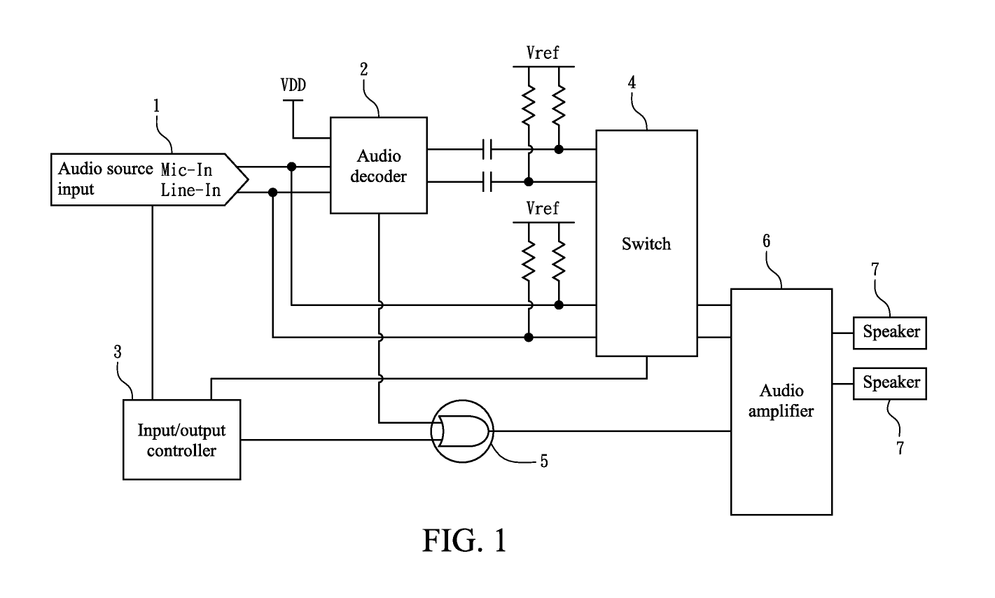

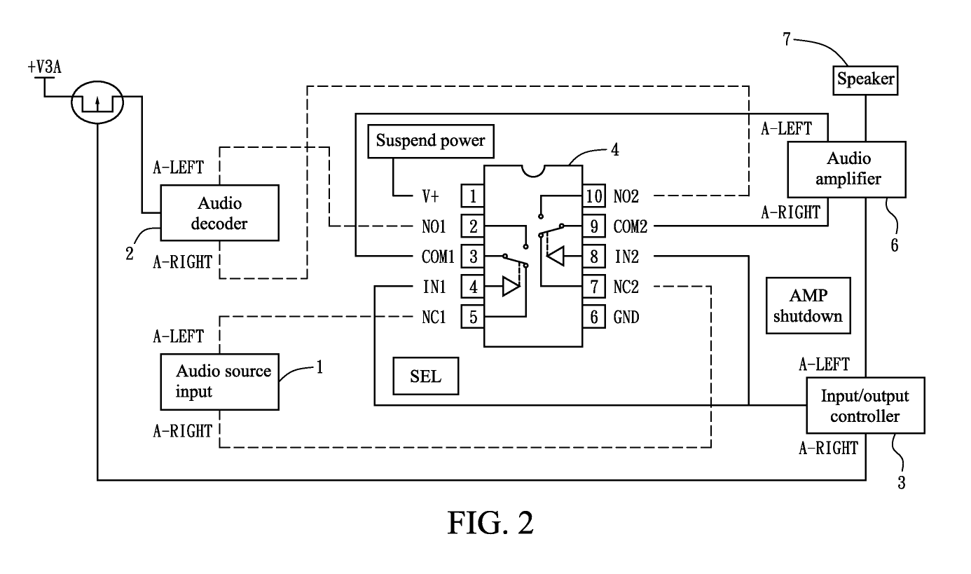

Please refer to FIG. 1 and FIG. 2, which show circuit diagrams of an audio playing circuit for a computer, especially for a portable computer, according to an embodiment of the present invention. The embodiment comprises: an audio source input 1 (Mic-in/Line-in) to connect with an external audio apparatus (not shown in the figures); an audio decoder 2 coupled to the audio source input 1, to decode an audio signal; an input/output controller 3 coupled to the audio source input 1; a switch 4 coupled to the audio source input 1 and the audio decoder 2, to select an audio signal according to the input/output controller 3; an audio amplifier 6 coupled to the switch 4, to amplify the audio signal; and a speaker 7 coupled to the audio amplifier 6, to voice the signal from the audio amplifier 6; wherein if the computer is in OFF state, then the input/output controller 3 activates the switch 4 to select the audio signal directly from the audio source input 1, otherwise the input/output controller 3 select the audio signal decoded by the audio decoder 2. After an audio signal of the external audio apparatus is added into the audio source input 1, the input/output controller 3 controls the audio signal by means of the switch 4 to travel to the audio amplifier 6 with or without being decoded, according to the on/OFF state of the computer. In the exemplary embodiment, the switch 4 is composed of a dual SPDT analog switch.

In addition, the audio playing circuit of the embodiment further comprises a time delay unit 5, which is coupled to the audio decoder 2, the audio amplifier 6, and the input/output controller 3. Here the time delay unit 5 is composed of an “OR” logic gate. If the computer is being turned off and an audio signal is added to the audio source input 1, the input/output controller 3 activates the time delay unit 5 to delay turning on of the audio amplifier 6 to diminish the noise impact once the audio source input 1 acts.

When the computer is working well in ON state, the input/output controller 3 will activate the switch 4 to select the audio signal from the audio decoder 2 as its input signal, so that the audio signal travels sequentially through the audio source input 1, the audio decoder 2, the switch 4, the audio amplifier 6, and the speaker 7 to be voiced out.

When the computer is turned off, the input/output controller 3 will activate the switch 4 to select the audio signal from the audio source input 1 as its input signal, so that the audio signal will bypass the audio decoder 2 and travels sequentially through the audio source input 1, the switch 4, the audio amplifier 6. Once an audio signal is detected to add to the audio source input 1, the input/output controller 3 activates the time delay unit 5 to delay turning on of the audio amplifier 6 to diminish the noise impact once the audio source input 1 acts. The audio signal is then voiced out via the speaker 7.

Particularly, the time delay unit 5 is optional in the embodiment. If the noise is tolerable in some situations, the input/output controller 3 can be set to connect and control the audio amplifier 6 directly, without a time delay unit. Moreover in another embodiment, an electrical power can be applied to the audio decoder 2, to avoid loss of the audio signal due to failure of the audio decoder 2 when the computer is shut down.

The foregoing descriptions disclose an audio playing circuit for a computer, wherein particularly after the computer is turned off, the computer can still play audio files of an external audio apparatus plugged into an audio source input of the computer with its built-in speakers. Furthermore, a time delay unit is also provided to diminish the noise once the audio playing circuit is turned on.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An audio playing circuit for a computer, comprising:
an audio source input, to connect with an external audio apparatus;
an audio decoder coupled to the audio source input, to decode an audio signal;
an input/output controller, coupled to the audio source input;
a switch, coupled to the audio source input and the audio decoder, to select an audio signal according to the input/output controller;
an audio amplifier coupled to the switch, to amplify the audio signal; and
a speaker coupled to the audio amplifier, to voice the signal from the audio amplifier;
wherein the input/output controller activates the switch to select the audio signal directly from the audio source input, if the computer is in OFF state.

2. The audio playing circuit of claim 1, wherein the external audio apparatus is selected from an MP3 player, an MP4 player, a radio, or the other audio apparatus.

3. The audio playing circuit of claim 1, wherein the input/output controller activates the switch to select the audio signal decoded by the audio decoder, if the computer is in ON state.

4. The audio playing circuit of claim 1, further comprising:
a time delay unit activated by the input/output controller, to delay turning on of the audio amplifier to diminish the noise impact once the audio source input acts, if the input/output controller detects both turning off of the computer and existing of an audio signal in the audio source input.

5. The audio playing circuit of claim 4, wherein the time delay unit is composed of an “OR” logic gate.

6. The audio playing circuit of claim 1, wherein the input/output controller delays turning on of the audio amplifier to diminish the noise impact once the audio source input acts, if the input/output controller detects both turning off of the computer and existing of an audio signal in the audio source input.

7. The audio playing circuit of claim 1, wherein the switch is composed of a dual SPDT analog switch.
